(19) United States
(12) Patent Application Publication
(10) Pub. No.: US 2025/0277359 A1
(43) Pub. Date: Sep. 4, 2025

(54) FLUSH WATER TANK DEVICE, AND FLUSH TOILET APPARATUS INCLUDING THE SAME

(71) Applicant: TOTO LTD., Fukuoka (JP)

(72) Inventors: Mao KAMEZAKI, Fukuoka (JP); Hideaki KASHIMURA, Fukuoka (JP); Haruki MATSUDA, Fukuoka (JP); Koki SHINOHARA, Fukuoka (JP); Mitsuhiro SUENAGA, Fukuoka (JP)

(21) Appl. No.: 19/060,118

(22) Filed: Feb. 21, 2025

(30) Foreign Application Priority Data
Feb. 29, 2024 (JP) 2024-029550

(51) Int. Cl. E03D 1/34

(52) U.S. Cl. CPC E03D 1/34; E03D 2201/30

(57) ABSTRACT

The present invention provides a flush water tank device including an outer tank, an inner tank disposed inside the outer tank, a water supply valve, a first water discharge/stop switching mechanism disposed inside the outer tank and outside the inner tank to switch supply and stop of flush water stored in the outer tank to the flush toilet main body, and a second water discharge/stop switching mechanism disposed inside the inner tank to switch supply and stop of flush water stored in the inner tank to the flush toilet main body, the water supply valve is configured to supply flush water into the inner tank, and the flush water supplied into the inner tank overflows from two or more sides of the inner tank to flow into the outer tank.

### CROSS-REFERENCE TO RELATED APPLICATION

This application claims the benefit of Japanese Patent Application No. 2024-029550 filed on Feb. 29, 2024, which is incorporated by reference herein in its entirety.

### BACKGROUND OF THE INVENTION

### Field of the Invention

The present invention relates to a flush water tank device, particularly to a flush water tank device attached to a flush toilet main body for use to supply flush water, and a flush toilet apparatus including the flush water tank device.

### Description of the Related Art

In Japanese Utility Model Laid-Open No. 6-056183 (Patent Literature 1), a toilet flushing water supply device is described. In the toilet flushing water supply device, a tank for storing flush water is divided into two by a partition plate, and a discharge valve is provided in each of the divided tanks. In addition, on one side of the tank, which is separated by the partition plate, a ball tap faucet is provided, and flush water supplied from a water supply source flows in. If a water level in the tank on the side on which the ball tap faucet is provided rises beyond the height of the partition plate, flush water flows over a top edge of the partition plate and into a side on which the ball tap faucet is not provided. In the toilet flushing water supply device described in Patent Literature 1, flush water is supplied to both the tanks separated by the partition plate through one water supply valve (ball tap faucet).

As in the toilet flushing water supply device described in Patent Literature 1, a configuration in which the discharge valve is provided in each of divided flush water tanks is capable of accurately setting an amount of flush water supplied via each discharge valve and is therefore effective in saving water and improving flushing performance. In the toilet flushing water supply device described in Patent Literature 1, however, there is a problem that it is difficult to design the flush water tank with a low profile because of a structure in which flush water supplied from the water supply valve flows over the partition plate and flows from one of the tanks into the other tank. That is, in general, various mechanisms and electrical components, such as a device for driving the discharge valve, are arranged above the water surface of the flush water tank and cause a failure if covered with water. Considering that flush water may flow over the partition plate, however, it is necessary to secure a predetermined space above the height of the overflowing flush water before arranging the electrical components and the like. Consequently, in the toilet flushing water supply device described in Patent Literature 1, it is necessary to secure a large space above the top edge of the partition plate, and this makes it difficult to design the flush water tank with the low profile.

Therefore, an object of the present invention is to provide a flush water tank device that can be designed with a low profile while including a plurality of tanks for storing flush water, and a flush toilet apparatus including the flush water tank device.

### SUMMARY OF THE INVENTION

To solve the above-described problems, the present invention provides a flush water tank device which is attached to a flush toilet main body for use to supply flush water, including an outer tank for storing flush water to be supplied to the flush toilet main body, an inner tank made of resin, which is disposed inside the outer tank and stores flush water to be supplied to the flush toilet main body, a water supply valve that switches supply and stop of flush water to be stored in the outer tank and the inner tank, a first water discharge/stop switching mechanism disposed inside the outer tank and outside the inner tank to switch supply and stop of flush water stored in the outer tank to the flush toilet main body, and a second water discharge/stop switching mechanism disposed inside the inner tank to switch supply and stop of flush water stored in the inner tank to the flush toilet main body, wherein the water supply valve is configured to supply flush water into the inner tank, and the flush water supplied into the inner tank overflows from two or more sides of the inner tank to flow into the outer tank.

According to the present invention including this configuration, the water supply valve is configured to supply flush water into the inner tank, and the flush water supplied into the inner tank overflows from the two or more sides of the inner tank to flow into the outer tank. Therefore, an edge over which the flush water flows can be lengthened, and a water level of flush water flowing over the edge of the inner tank can be kept low. Consequently, a space to be provided above the inner tank can be set low, and the flush water tank device can be designed with a low profile.

In the present invention, preferably, the inner tank is configured so that a length of an outer perimeter of an upper end of the inner tank is ½ or more of a length of an outer perimeter of an upper end of the outer tank.

According to the present invention including this configuration, since the length of the outer perimeter of the upper end of the inner tank is set to ½ or more of the length of the outer perimeter of the upper end of the outer tank, an edge of the inner tank over which the flush water flows can be set sufficiently long, and the water level of the flush water flowing over the edge of the inner tank can be kept low.

In the present invention, preferably, the inner tank is configured so that a cross-sectional area varies in a height direction and so that a cross-sectional area of an upper part of the inner tank is larger than a cross-sectional area of a lower part.

According to the present invention including this configuration, since the inner tank is configured so that the cross-sectional area of the upper part of the inner tank is larger than the cross-sectional area of the lower part, the edge of the inner tank over which the flush water flows can be formed long. As a result, the water level of the flush water flowing over the edge of the inner tank can be kept low. Furthermore, since the inner tank is configured so that the cross-sectional area of the upper part is larger than the cross-sectional area of the lower part, a large amount of flush water having a large head pressure is stored in the inner tank. Consequently, an instantaneous flow rate of flush water drained from the inner tank can be increased, and the flush toilet main body can be effectively flushed.

In the present invention, preferably, the water supply valve is configured to cause flush water to flow into the inner tank from a water supply port provided below the water surface of the inner tank.

According to the present invention including this configuration, since the water supply valve is configured to cause flush water to flow into the inner tank from the water supply port provided below the water surface of the inner tank, rippling of the flush water flowing into the inner tank from the water supply port can be suppressed. Consequently, even if the space above the inner tank is set low, concern of equipment disposed above the inner tank being covered with water can be reduced, and the flush water tank device can be designed with a low profile.

In the present invention, preferably, the inner tank is configured so that a length of an outer perimeter of an upper end of the inner tank is longer than a length of an outer perimeter of an upper end of the outer tank.

According to the present invention including this configuration, since the inner tank is configured so that the length of the outer perimeter of the upper end of the inner tank is longer than the length of the outer perimeter of the upper end of the outer tank, the edge of the inner tank over which flow water flows can be set extremely long, and the water level of the flush water flowing over the edge of the inner tank can be kept sufficiently low.

Furthermore, the present invention provides a flush toilet apparatus which is flushed with flush water stored in a flush water tank, and the flush toilet apparatus includes a flush toilet main body including a bowl, a rim spout port, and a jet spout port, and the flush water tank device of the present invention that supplies flush water to the rim spout port and the jet spout port of the flush toilet main body.

According to a flush water tank device of the present invention and a flush toilet apparatus including the same, a low profile can be achieved while providing a plurality of tanks for storing flush water.

### BRIEF DESCRIPTION OF THE DRAWINGS

FIG. 1 is a block diagram showing an entire configuration of a flush toilet apparatus according to an embodiment of the present invention;

FIG. 2 is a top view showing a schematic configuration of the flush toilet apparatus according to the embodiment of the present invention;

FIG. 3 is a front cross-sectional view showing a schematic configuration of a flush water tank device provided in the flush toilet apparatus according to the embodiment of the present invention;

FIG. 4 is a cross-sectional view showing a structure of a ball tap built in the flush water tank device according to the embodiment of the present invention;

FIG. 5 is a cross-sectional view showing a structure of a hydraulic drive mechanism built in the flush water tank device according to the embodiment of the present invention; and

FIG. 6 is a time chart showing the operation of a flush toilet apparatus according to the embodiment of the present invention.

### DETAILED DESCRIPTION OF THE INVENTION

Next, with reference to the accompanying drawings, a flush water tank device according to an embodiment of the present invention and a flush toilet apparatus including the same will be described.

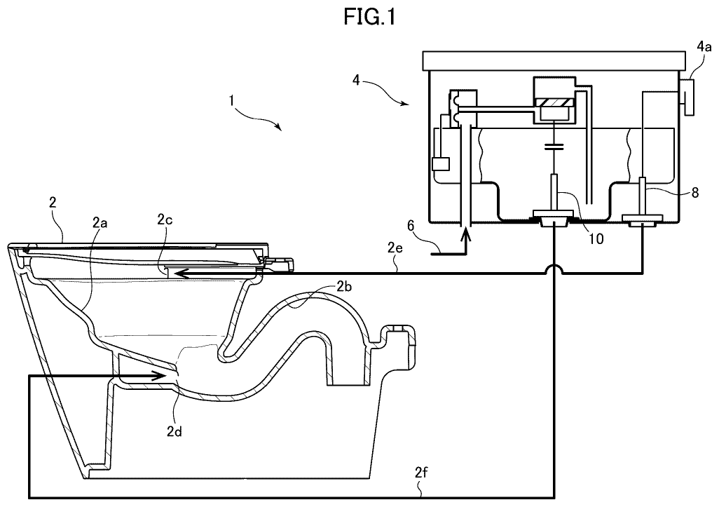

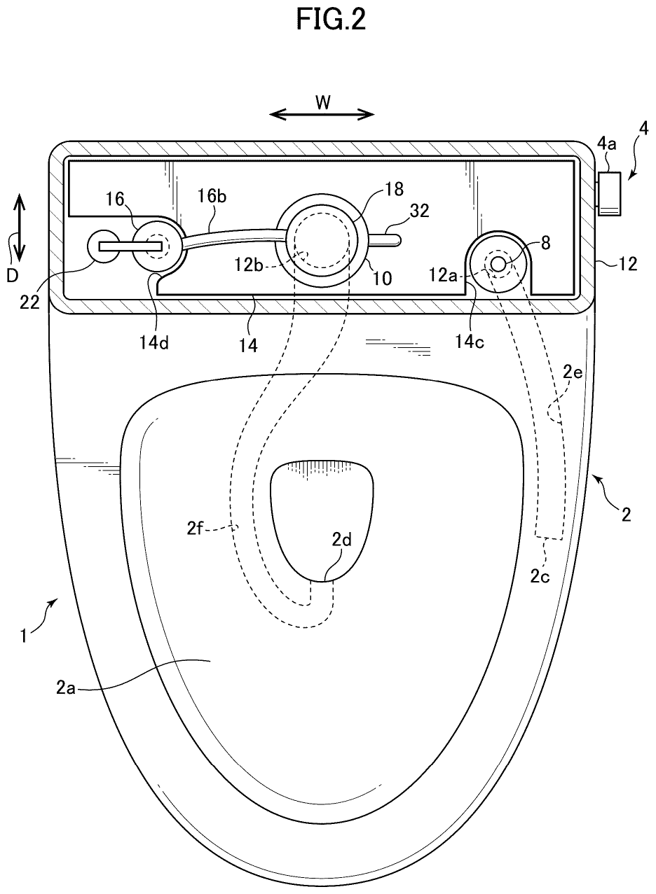

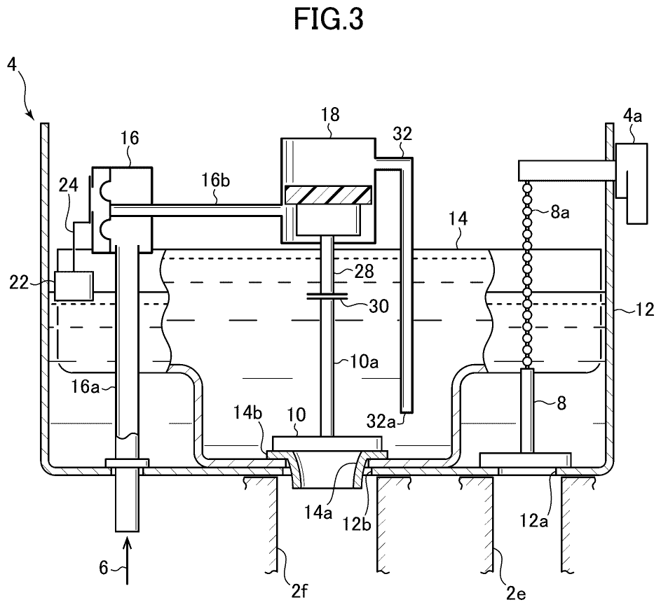

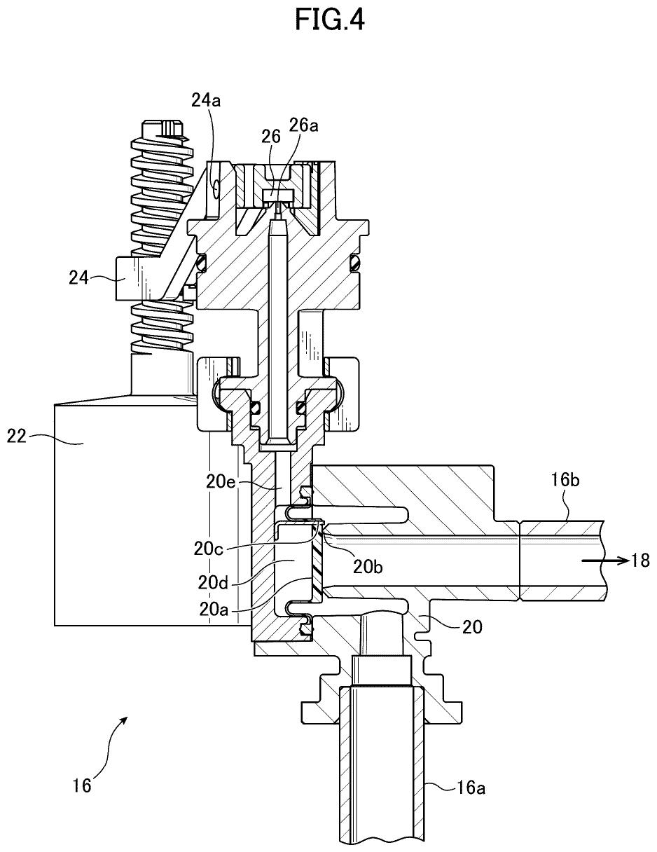

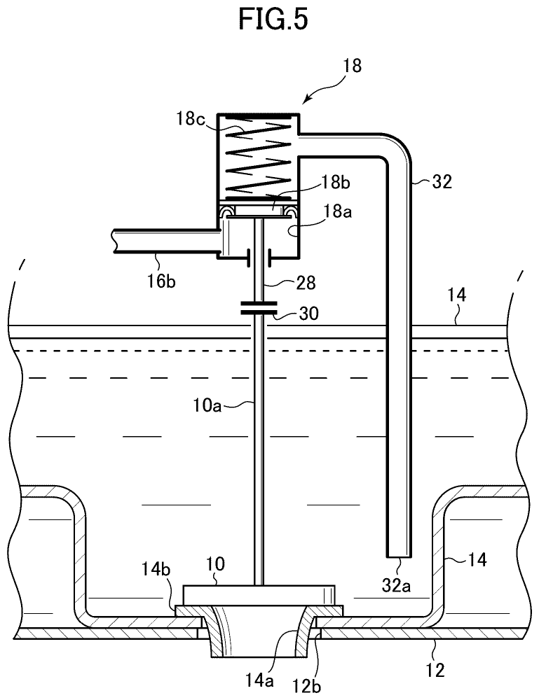

FIG. 1 is a block diagram showing an entire configuration of the flush toilet apparatus according to the embodiment of the present invention. FIG. 2 is a top view showing a schematic configuration of the flush toilet apparatus according to the embodiment of the present invention. FIG. 3 is a front cross-sectional view showing a schematic configuration of a flush water tank device provided in the flush toilet apparatus according to the embodiment of the present invention. FIG. 4 is a cross-sectional view showing a structure of a ball tap built in the flush water tank device according to the embodiment of the present invention. FIG. 5 is a cross-sectional view showing a structure of a hydraulic drive mechanism built in the flush water tank device according to the embodiment of the present invention.

As shown in FIGS. 1 and 2, a flush toilet apparatus 1 according to the embodiment of the present invention includes a flush toilet main body 2 and a flush water tank device 4 disposed at the rear of the flush toilet main body 2. The flush toilet apparatus 1 of the present embodiment is configured to be flushed by operating a lever handle 4a provided in the flush water tank device 4 after use.

The flush toilet main body 2 includes a bowl 2a and a discharge trap conduit 2b extending from a lower part of the bowl 2a. Furthermore, a rim spout port 2c is provided in a top edge portion of the bowl 2a, and a jet spout port 2d is provided in the lower part of the bowl 2a. During toilet flushing, flush water is spouted from each of the rim spout port 2c and the jet spout port 2d at a predetermined timing, and a waste receiving surface of the bowl 2a is flushed, while waste and flush water in the bowl 2a are drained to the discharge trap conduit 2b. The waste and flush water drained to the discharge trap conduit 2b are drained through a discharge socket (not shown) to a sewage pipe (not shown).

Flush water is supplied to the flush water tank device 4 from a water supply source 6 such as a water supply, and the supplied flush water is stored in the flush water tank device 4. Furthermore, in the flush water tank device 4, a first discharge valve 8 that is a first water discharge/stop switching mechanism, and a second discharge valve 10 that is a second water discharge/stop switching mechanism are built and are configured to open and close drain ports, respectively, provided in a bottom portion of the flush water tank device 4.

In the present embodiment, by opening the first discharge valve 8, flush water is spouted from the rim spout port 2c through a rim conduit 2e formed inside the flush toilet main body 2. Furthermore, by opening the second discharge valve 10, flush water is spouted from the jet spout port 2d through a jet conduit 2f formed inside the flush toilet main body 2.

Next, with reference to FIGS. 2 and 3, an internal structure of the flush water tank device 4 will be described.

As shown in FIGS. 2 and 3, the flush water tank device 4 includes an outer tank 12, an inner tank 14 disposed inside the outer tank, the first discharge valve 8 disposed in the outer tank 12, the second discharge valve 10 disposed in the inner tank 14, a ball tap 16 that is a water supply valve, and a hydraulic drive mechanism 18.

The outer tank 12 and the inner tank 14 are containers configured to store flush water to be supplied to the flush toilet main body 2. In the present embodiment, the outer tank 12 is made of ceramic, and the inner tank 14 disposed inside the outer tank 12 is made of resin.

Furthermore, as shown in FIG. 3, a first drain port 12a and a second drain port 12b are provided on a bottom surface of the outer tank 12, and in the present embodiment, these drain ports are formed in a circular shape. Here, the flush water stored inside the outer tank 12 (and outside the inner tank 14) flows through the first drain port 12a into the rim conduit 2e of the flush toilet main body 2, and the flush water stored inside the inner tank 14 flows through the second drain port 12b into the jet conduit 2f of the flush toilet main body 2.

The inner tank 14 is disposed on the bottom surface of the outer tank 12, and the lower part of the inner tank 14 is submerged in the flush water stored in the outer tank 12. Furthermore, a circular drain port 14a is formed on the bottom surface of the inner tank 14. The drain port 14a of the inner tank 14 is disposed concentrically to match the second drain port 12b provided in the outer tank 12. That is, in the present embodiment, the center of the circular second drain port 12b and the circular drain port 14a coincide in top view. Therefore, the flush water in the inner tank 14 flows into the jet conduit 2f of the flush toilet main body 2 through the drain port 14a of the inner tank 14 and the second drain port 12b of the outer tank 12.

Furthermore, as shown in FIG. 3, in the present embodiment, the drain port 14a of the inner tank 14 is composed of a drain port forming member 14b composed separately from a main body part of the inner tank 14. The drain port forming member 14b is a tubular member and is water-tightly attached to the bottom surface of the inner tank 14 to form the drain port 14a inside. Furthermore, a seat surface is provided at an upper end of the drain port forming member 14b, and the drain port 14a is closed when the second discharge valve 10 is seated on the seat surface. Therefore, in the present embodiment, the seat surface on which the second discharge valve 10 is seated is composed of a member separate from the inner tank 14.

Furthermore, as shown in FIG. 2, the outer tank 12 of the flush water tank device 4 is formed in a substantially rectangular shape that is long in a width direction of the flush toilet main body 2 (arrow W direction in FIG. 2) and short in a depth direction (arrow D direction in FIG. 2) in top view. Furthermore, the inner tank 14 disposed inside the outer tank 12 is also formed long in the width direction and short in the depth direction in top view and is irregularly shaped to avoid the first discharge valve 8 and the ball tap 16.

Specifically, in the present embodiment, the ball tap 16 is disposed in a front left end portion (lower left corner in FIG. 2) in the outer tank 12, and the first discharge valve 8 is disposed in a front right end portion (lower right corner in FIG. 2). The inner tank 14 is provided with cutouts 14c and 14d in opposite front end portions in the width direction in top view to avoid the ball tap 16 and the first discharge valve 8.

That is, the inner tank 14 includes an upper part having about the same outer shape as the outer tank 12 in top view. The cutout 14c that is U-shaped is then provided in the inner tank 14 in a portion in which the first discharge valve 8 is disposed, and the cutout 14d is provided in a portion in which the ball tap 16 is disposed, so that the valve and ball tap do not interfere with the inner tank 14.

Furthermore, in the present embodiment, the inner tank 14 is configured to have an upper end at the same height along an entire perimeter. Consequently, when the flush water supplied into the inner tank 14 overflows to flow into the outer tank 12, flush water flowing over the entire perimeter of the upper end edge of the inner tank 14 flows into the outer tank. Consequently, an edge over which the flush water in the inner tank 14 flows can have a length sufficiently increased. Preferably, the inner tank 14 is configured so that the flush water in the inner tank 14 overflows from two or more sides of the inner tank 14 to flow into the outer tank 12.

Furthermore, as shown in FIG. 2, in the present embodiment, an outer peripheral wall of the inner tank 14 is formed in a shape substantially identical to a shape of an inner peripheral wall of the outer tank 12, and a small gap is formed between the outer peripheral wall of the inner tank 14 and the inner peripheral wall of the outer tank 12. As a result, in the present embodiment, a length of an outer perimeter of the upper end of the inner tank 14 is longer than a length of an outer perimeter of an upper end of the outer tank 12 (the length of the outer perimeter is increased by providing the cutouts 14c and 14d in the inner tank 14). Consequently, it is possible to extremely increase the length of an edge over which flush water flows when the flush water supplied into the inner tank 14 overflows to flow into the outer tank. Preferably, the length of the outer perimeter of the upper end of the inner tank 14 is set to ½ or more of the length of the outer perimeter of the upper end of the outer tank 12.

On the other hand, as shown in FIG. 3, a stepped portion is formed on each side of the inner tank 14 in the width direction, and a lower part of the inner tank is configured to have a reduced width. That is, the inner tank 14 is substantially formed in a T-shape in front view so that at least the lower part of the inner tank 14 is submerged in flush water stored in the outer tank 12. In other words, the inner tank 14 is configured so that a cross-sectional area of the inner tank varies in a height direction and so that a horizontal cross-sectional area in the upper part of the inner tank 14 is larger than a horizontal cross-sectional area in the lower part. The upper part of the inner tank 14 is formed large, so that flush water having high potential energy is stored in the inner tank 14. Consequently, the hydraulic head pressure of the flush water drained from the inner tank 14 can be increased, and an instantaneous flow rate of the drained flush water can be increased.

Thus, by irregularly shaping the inner tank 14 with resin, sufficient volume is acquired in the inner tank 14 while suppressing a dimension of the flush water tank device 4 in the depth direction. Additionally, the inner tank 14 made of resin can be configured with a thinner wall surface than an inner tank made of ceramic, and hence the volume in the outer tank 12 can be effectively utilized.

Next, the first discharge valve 8 that is the first water discharge/stop switching mechanism is a valve body disposed to open and close the first drain port 12a provided in the outer tank 12, and the first drain port 12a is opened by pulling the first discharge valve 8 upward. Consequently, the flush water in the outer tank 12 is drained to the rim conduit 2e (FIG. 1) of the flush toilet main body 2 and spouted from the rim spout port 2c. Therefore, the first discharge valve 8, which is the first water discharge/stop switching mechanism, switches the supply and stop of the flush water stored in the outer tank 12 to the flush toilet main body 2.

In the present embodiment, a bead chain 8a (FIG. 3) coupled to the first discharge valve 8 is pulled by a user rotating and operating the lever handle 4a provided in the flush water tank device 4, and the first discharge valve 8 is pulled upward. As a modification, the present invention may include a configuration in which the first discharge valve 8 is pulled up based on a control signal from a remote controller (not shown) or a detection signal from a human sensor (not shown), to perform flushing.

Furthermore, in the present embodiment, the first discharge valve 8 is provided as the first water discharge/stop switching mechanism, and a configuration other than the first discharge valve 8 may be used as the first water discharge/stop switching mechanism. For example, a jet pump (not shown) that causes flush water stored in the outer tank 12 to flow into the flush toilet main body may be used as the first water discharge/stop switching mechanism. In this case, a jet pump nozzle (not shown) is disposed inside the outer tank 12, and through this nozzle, part of the flush water supplied via a water supply valve such as the ball tap 16 is injected. By injecting flush water from the nozzle in the outer tank 12, the flush water stored in the outer tank 12 can be entrained, and the flush water in the outer tank 12 can flow into the flush toilet main body by jet pump action. In addition to this jet pump (not shown), an arbitrary configuration that switches supply and stop of flush water to the flush toilet main body 2 may be used as the first water discharge/stop switching mechanism.

Next, the second discharge valve 10 that is a second water discharge/stop switching mechanism is a valve body disposed to open and close the drain port 14a provided in the inner tank 14, and by pulling the second discharge valve 10 upward, the second discharge valve 10 is unseated from the seat surface of the drain port 14a, to open the drain port 14a. Consequently, the flush water in the inner tank 14 is drained from the drain port 14a, flows through the second drain port 12b into the jet conduit 2f (FIG. 1) of the flush toilet main body 2, and is spouted from the jet spout port 2d. Therefore, the second discharge valve 10, which is the second water discharge/stop switching mechanism, switches the supply and stop of the flush water stored in the inner tank 14 to the flush toilet main body 2.

In the present embodiment, the second discharge valve 10 is configured to be pulled up from the drain port 14a by the hydraulic drive mechanism 18. That is, the second discharge valve 10 is a valve body including a valve shaft 10a extending upward, and the valve shaft 10a is pulled up by the hydraulic drive mechanism 18. Then, when pulled up to a predetermined height, the second discharge valve 10 is disconnected from the hydraulic drive mechanism 18 and gently descends to close the drain port 14a. The configuration of the hydraulic drive mechanism 18 will be described later, and the present invention may be applied to a flush water tank device that is not provided with the hydraulic drive mechanism 18.

Furthermore, in the present embodiment, the second discharge valve 10 is provided as the second water discharge/stop switching mechanism, and a configuration other than the second discharge valve 10 may be used as the second water discharge/stop switching mechanism. For example, a jet pump (not shown) that causes flush water stored in the inner tank 14 to flow into the flush toilet main body may be used as the second water discharge/stop switching mechanism. In this case, a jet pump nozzle (not shown) is disposed in the inner tank 14, and through this nozzle, part of the flush water supplied via a water supply valve such as the ball tap 16 is injected. By injecting flush water from the nozzle in the inner tank 14, the flush water stored in the inner tank 14 can be entrained, and the flush water in the inner tank 14 can flow into the flush toilet main body by jet pump action. In addition to this jet pump (not shown), an arbitrary configuration that switches supply and stop of flush water to the flush toilet main body 2 may be used as the second water discharge/stop switching mechanism.

Furthermore, the ball tap 16, which is the water supply valve, is configured so that flush water supplied from the water supply source 6 flows into the ball tap through an inflow pipe 16a and is configured to switch supply and stop of flush water to be stored in the outer tank 12 and the inner tank 14.

Next, with reference to FIG. 4, the configuration of the ball tap 16 will be described.

As shown in FIG. 4, the ball tap 16 includes a main body 20 to which the inflow pipe 16a and an outflow pipe 16b are connected, a main valve body 20a disposed in the main body 20, a valve seat 20b on which the main valve body 20a is seated, an arm 24 rotated by a float 22, and a pilot valve 26 moved by the rotation of the arm 24. That is, the ball tap 16 includes the float 22 that operates in conjunction with a water level in the flush water tank device 4, and the float 22 is configured to supply flush water to the hydraulic drive mechanism 18 when lowering to a predetermined position.

The main body 20 is a member having a lower part including a connecting portion to the inflow pipe 16a and having one side including a connecting portion to the outflow pipe 16b. Furthermore, the valve seat 20b is formed inside the main body 20, and the valve seat 20b communicates with the outflow pipe 16b connected to the connecting portion. Furthermore, inside the main body 20, the main valve body 20a is disposed to open and close the valve seat 20b and is configured so that when the valve is opened, tap water flowing from the inflow pipe 16a flows through the valve seat 20b, to flow out to the outflow pipe 16b. The outflow pipe 16b is then connected to the hydraulic drive mechanism 18.

The main valve body 20a is a diaphragm valve body that is generally disc-shaped and is attached to the main body 20 so that the main valve body can be seated on and unseated from the valve seat 20b. Furthermore, a bleed hole 20c is provided in a peripheral edge portion of the main valve body 20a. Furthermore, in the main valve body 20a, a pressure chamber 20d is formed on a side of the main valve body 20a opposite to the valve seat 20b (left side in FIG. 4). That is, the pressure chamber 20d is defined by an inner wall surface of the main body 20 and the main valve body 20a, and when the pressure in the pressure chamber 20d increases, the main valve body 20a is pressed against the valve seat 20b and seated on the valve seat 20b by this pressure.

Furthermore, a pressure passage 20e extends upward to communicate with the pressure chamber 20d provided in the main body 20, and a pilot valve port 26a is provided at an upper end of the pressure passage 20e. The pilot valve port 26a is opened upward and is configured to be opened and closed by the pilot valve 26.

On one hand, the float 22 is supported by the arm 24, and the arm 24 is rotatably supported by a support shaft 24a. Furthermore, the pilot valve 26 is coupled to the arm 24, and the pilot valve 26 is configured to move in an up-down direction together with the rotation of the arm 24. In the present embodiment, the float 22 is disposed in the outer tank 12 and moved vertically depending on the water level in the outer tank 12. Consequently, when the water level in the outer tank 12 is raised to or above a predetermined water level, the float 22 is pushed upward, and the pilot valve 26 is accordingly moved downward and seated on the pilot valve port 26a, to close the pilot valve port. On the other hand, when the flush water in the outer tank 12 is discharged to lower the water level, the float 22 moves downward, and the pilot valve 26 moves upward, to open the pilot valve port 26a. Consequently, when toilet flushing is on standby in a state in which the water level in the outer tank 12 is higher than the predetermined water level, the pilot valve port 26a of the main body 20 is closed.

Furthermore, tap water flowing through the inflow pipe 16a into the main body 20 flows into an annular space around the valve seat 20b and flows from here through the bleed hole 20c of the main valve body 20a into the pressure chamber 20d. In this state in which the pilot valve port 26a is closed by the pilot valve 26, there is no path for tap water flowing from the bleed hole 20c into the pressure chamber 20d to flow out, and the pressure in the pressure chamber 20d rises. When the pressure in the pressure chamber 20d rises in this way, the main valve body 20a is pressed toward the valve seat 20b (rightward in FIG. 4) by this pressure, and the valve seat 20b is closed by the main valve body 20a.

In contrast, when the first discharge valve 8 is opened by the flushing operation and the water level in the outer tank 12 becomes lower than the predetermined water level, the float 22 descends, and the pilot valve 26 moves upward, to open the pilot valve port 26a. When the pilot valve port 26a is opened, water in the pressure chamber 20d flows out of the pilot valve port 26a and the pressure in the pressure chamber 20d decreases. Consequently, the main valve body 20a is moved to be pulled away from the valve seat 20b (leftward in FIG. 4), to open the valve seat 20b. Consequently, in this state in which the pilot valve port 26a is opened, the pressure in the pressure chamber 20d does not increase, so that the valve seat 20b is opened.

Next, with reference to FIG. 5, the configuration of the hydraulic drive mechanism 18 will be described.

The hydraulic drive mechanism 18 is configured to drive the second discharge valve 10 using a water supply pressure of the flush water supplied from the water supply to the flush water tank device 4. Specifically, the hydraulic drive mechanism 18 includes a cylinder 18a into which water supplied from the ball tap 16 flows, a piston 18b slidably disposed in the cylinder 18a, and a rod 28 that protrudes from a lower end of the cylinder 18a to drive the second discharge valve 10. Furthermore, a spring 18c is disposed inside the cylinder 18a, to bias the piston 18b downward, and a packing is attached to the piston 18b, to acquire watertightness between an inner wall surface of the cylinder 18a and the piston 18b. In addition, a clutch mechanism 30 is provided at a lower end of the rod 28, and the rod 28 and the valve shaft 10a of the second discharge valve 10 are coupled/decoupled by the clutch mechanism 30.

The cylinder 18a is a cylindrical member, has an axis oriented in a vertical direction and can slidably receive the piston 18b inside. Furthermore, the outflow pipe 16b extending from the ball tap 16 is connected to a lower end of the cylinder 18a, and the flush water flowing out of the ball tap 16 flows into the cylinder 18a. Consequently, the piston 18b in the cylinder 18a is pushed up against a biasing force of the spring 18c by the water flowing into the cylinder 18a.

In addition, an outflow hole is provided in an upper end of the cylinder 18a, and a water supply pipe 32 is connected to the outflow hole. Therefore, when water flows into the cylinder 18a through the outflow pipe 16b connected to a lower part of the cylinder 18a, the piston 18b is pushed upward from the lower part of the cylinder 18a. Then, when the piston 18b is pushed up to a position above the outflow hole, the water flowing into the cylinder 18a flows out of the outflow hole to the water supply pipe 32.

The water supply pipe 32 is a pipe extending downward from the outflow hole provided in the upper end of the cylinder 18a. The flush water flowing out of the cylinder 18a flows into the inner tank 14 from a water supply port 32a at a lower end of the water supply pipe 32. The water supply port 32a at the lower end of the water supply pipe 32 is located below the water surface of the flush water in the inner tank 14 on standby. Therefore, the ball tap 16 is configured to cause flush water to flow into the inner tank 14 from the water supply port 32a provided below the water surface of the inner tank 14. Thus, since flush water is supplied into the inner tank 14 from below the water surface of the stored flush water, ripples on the water surface of the flush water flowing into the inner tank 14 can be suppressed.

The rod 28 is a bar-shaped member connected to a lower surface of the piston 18b and extends to protrude downward from the cylinder 18a via a through hole formed on a bottom surface of the cylinder 18a. Furthermore, the valve shaft 10a of the second discharge valve 10 is connected to the lower end of the rod 28 via the clutch mechanism 30, and the rod 28 couples the piston 18b and the second discharge valve 10. Consequently, when water flows into the cylinder 18a to push up the piston 18b, the rod 28 connected to the piston 18b lifts the second discharge valve 10 upward, and the second discharge valve 10 is opened.

Furthermore, a gap is provided between the rod 28 protruding from the bottom of the cylinder 18a and the inner wall of the through hole of the cylinder 18a, and part of the water flowing into the cylinder 18a flows out of this gap. The water flowing out of the gap flows into the inner tank 14. This gap is comparatively narrow and has a large flow channel resistance. Therefore, even if water flows out of the gap, the pressure in the cylinder 18a increases due to the water flowing through the outflow pipe 16b into the cylinder 18a, and the piston 18b is pushed up against the biasing force of the spring 18c.

Furthermore, the clutch mechanism 30 removably couples the rod 28 and the second discharge valve 10. The clutch mechanism 30 is configured to disconnect the valve shaft 10a of the second discharge valve 10 from the rod 28, when the second discharge valve 10 is lifted up together with the rod 28 along a predetermined distance. While the clutch mechanism 30 is disconnected, the second discharge valve 10 is no longer linked to the movement of the piston 18b and the rod 28, and the second discharge valve 10 descends with decrease in water level in the inner tank 14, to close the drain port 14a of the inner tank 14.

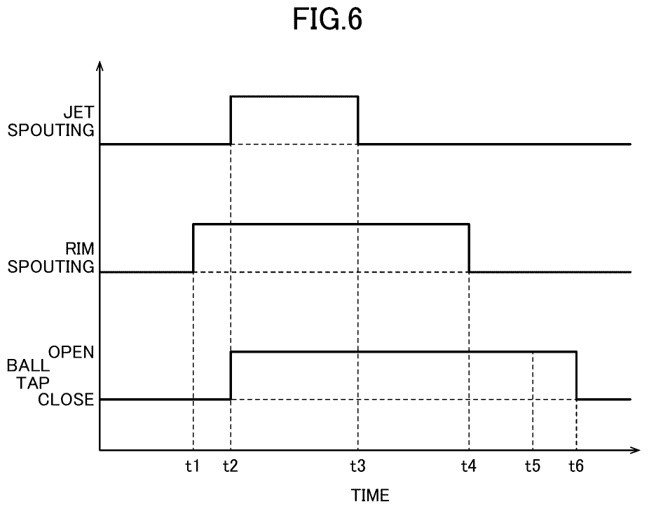

Next, newly with reference to FIG. 6, an operation of the flush toilet apparatus 1 according to the embodiment of the present invention will be described.

FIG. 6 is a time chart showing the operation of the flush toilet apparatus 1 according to the embodiment of the present invention, and shows a state of jet spouting, a state of rim spouting, and a state of the ball tap in order from the top.

First, in a standby state for toilet flushing, the first drain port 12a of the outer tank 12 and the drain port 14a of the inner tank 14 are closed by the first discharge valve 8 and the second discharge valve 10, respectively. Furthermore, in the standby state, flush water is stored up to a predetermined initial water level in each of the outer tank 12 and the inner tank 14. The initial water level of the outer tank 12 is set higher than the predetermined initial water level. Thus, the pilot valve port 26a of the main body 20 (FIG. 4) of the ball tap 16 is closed, and the valve seat 20b is closed by the main valve body 20a. In the present embodiment, the initial water level of the inner tank 14 is at a position higher than the initial water level of the outer tank 12, and flush water is stored almost to the upper end in the inner tank 14.

Next, at time t1 in FIG. 6, when the user rotates and operates the lever handle 4a (FIG. 3) of the flush water tank device 4 to perform toilet flushing, the bead chain 8a connected to this handle pulls up the first discharge valve 8. Consequently, the first discharge valve 8 is pulled away from the first drain port 12a, and the first drain port 12a is opened. When the first drain port 12a is opened, the flush water stored inside the outer tank 12 (outside the inner tank 14) flows from the first drain port 12a into the rim conduit 2e (FIG. 2) and is spouted from the rim spout port 2c. By rim spouting from the rim spout port 2c, a circulating flow is formed on the waste receiving surface of the bowl 2a, and the waste receiving surface is flushed.

As the flush water is drained from the first drain port 12a, the water level in the outer tank 12 decreases. Consequently, the float 22 of the ball tap 16 lowers to open the pilot valve 26 (FIG. 4). This decreases the pressure in the pressure chamber 20d, to open the main valve body 20a, and flush water is supplied through the outflow pipe 16b to the hydraulic drive mechanism 18.

When flush water is supplied to the hydraulic drive mechanism 18, the flush water flowing into the cylinder 18a (FIG. 5) pushes up the piston 18b against the biasing force of the spring 18c. Consequently, the rod 28 coupled to the piston 18b pulls up the valve shaft 10a of the second discharge valve 10, and the drain port 14a of the inner tank 14 is opened. That is, the second discharge valve 10 is driven by the water supply pressure of tap water supplied via the ball tap 16 and is opened.

At time t2 in FIG. 6, the drain port 14a is opened, and the flush water stored in the inner tank 14 flows through the drain port 14a and the second drain port 12b into the jet conduit 2f (FIG. 2) and is spouted from the jet spout port 2d. The jet spouting from the jet spout port 2d fills the discharge trap conduit 2b with water and induces siphon action. Due to occurrence of the siphon action, retained water and waste in the bowl 2a are suctioned into the discharge trap conduit 2b and drained to the sewage pipe (not shown).

Here, in a state in which the drain port 14a is closed, the interior of the jet conduit 2f is filled with flush water to a level of pooled water surface of the bowl 2a, and no flush water is in a space above this pooled water surface. Therefore, in a state before the second discharge valve 10 is opened, no flush water is at an upstream end in the jet conduit 2f.

When the second discharge valve 10 is opened, the space in which there is no flush water in the jet conduit 2f is filled in a brief time, and the flush water can be spouted from the jet spout port 2d at an early stage. In particular, according to the present embodiment, the cross-sectional area of an upper part of the inner tank 14 is larger than the cross-sectional area of a lower part, and hence the inner tank 14 includes a large volume at a high position. Consequently, a large amount of flush water having a high hydraulic head pressure can flow into the jet conduit 2f, and the instantaneous flow rate of the flush water spouted from the jet spout port 2d can be increased.

When the second discharge valve 10 is pulled up to the predetermined height together with the piston 18b of the hydraulic drive mechanism 18, the valve shaft 10a of the second discharge valve 10 is disconnected from the rod 28 by the clutch mechanism 30 (FIG. 5). Consequently, the second discharge valve 10 descends toward the drain port 14a as the water level in the inner tank 14 decreases. Then, at time t3 in FIG. 6, the second discharge valve 10 is seated at the drain port 14a, and the drain port 14a is closed. This stops the jet spouting from the jet spout port 2d.

In a state in which the main valve body 20a of the ball tap 16 is opened, the flush water supplied from the water supply source 6 (water supply) is supplied to the hydraulic drive mechanism 18 via the ball tap 16, and flows through the water supply pipe 32 (FIG. 5) connected to the cylinder 18a into the inner tank 14. Here, in a state in which the second discharge valve 10 is opened, the flow rate of the flush water flowing out of the drain port 14a of the inner tank 14 is larger than the flow rate of the flush water flowing through the water supply port 32a of the water supply pipe 32 into the inner tank 14, and hence the water level in the inner tank 14 decreases. Then, after the jet spouting is stopped at time t3 in FIG. 6 (after the second discharge valve 10 is closed), the flush water flowing in from the water supply pipe 32 raises the water level in the inner tank 14.

On the other hand, since the first discharge valve 8 is still in an opened state, the flush water in the outer tank 12 flows out of the first drain port 12a, and the water level in the outer tank 12 continues to decrease. Then, at time t4 in FIG. 6, when the water level in the outer tank 12 decreases to a predetermined dead water level, the first discharge valve 8 is seated on the first drain port 12a, and the first discharge valve 8 is closed. Consequently, the rim spouting from the rim spout port 2c is stopped.

Furthermore, even after the first discharge valve 8 is closed, the main valve body 20a of the ball tap 16 is maintained in an opened state, and the flush water supplied from the water supply source 6 (water supply) therefore flows into the inner tank 14 from the water supply port 32a of the water supply pipe 32 via the ball tap 16 and the hydraulic drive mechanism 18. At this time, since the water supply port 32a of the water supply pipe 32 is opened in the lower part of the inner tank 14, the water supply port 32a is located under the water surface of the flush water stored in the inner tank 14, and flush water flows from stored water into the inner tank 14. As a result, when the flush water flows from the water supply port 32a to the inner tank 14, splashing of flush water and ripples on the water surface in the inner tank 14 are suppressed.

When the water level in the inner tank 14 rises due to the inflow of flush water, at time t5 in FIG. 6 at which the inner tank 14 is full, the flush water begins to overflow from the inner tank 14. In the present embodiment, since the upper end of the inner tank 14 is formed at the same height along the entire perimeter, flush water overflows from the entire perimeter of the inner tank 14 to flow into the outer tank 12. In the present embodiment, since the edge of the inner tank 14 over which the flush water flows is formed extremely long, the water level of the flush water flowing over the edge of the inner tank 14 can be kept low. That is, the flush water overflowing from the inner tank 14 flows over the edge of the inner tank 14 while forming a thin water film on the edge of the inner tank 14 and flows into the outer tank 12. In other words, since the edge of the inner tank 14 is formed long, the flush water inflowing from the water supply port 32a at a predetermined flow rate only forms the thin water film on the edge and can flow out.

As flush water flows into the outer tank 12, the water level in the outer tank 12 begins to rise. Next, the water level in the outer tank 12 rises to a predetermined water level, and the float 22 of the ball tap 16 rises, to close the pilot valve 26 (FIG. 4). Thus, when the pilot valve 26 is closed, the flush water flowing into the pressure chamber 20d from the bleed hole 20c provided in the main valve body 20a of the ball tap 16 cannot flow out, and the pressure in the pressure chamber 20d increases. Then, at time t6 in

FIG. 6, the main valve body 20a is pressed by the pressure in the pressure chamber 20d and seated on the valve seat 20b, and the main valve body 20a is closed. This stops water supply from the water supply source 6 via the ball tap 16 to the hydraulic drive mechanism 18 and stops the supply of flush water into the inner tank 14.

Upon stopping the water supply to the hydraulic drive mechanism 18, the piston 18b (FIG. 5) in the cylinder 18a pushed up by the water supply is pushed down by the biasing force of the spring 18c. The rod 28 attached to the piston 18b accordingly lowers. The rod 28 lowers to a predetermined position, and the rod 28 is recoupled to the valve shaft 10a of the second discharge valve 10 by the clutch mechanism 30. As described above, toilet flushing is ended once, and the flush toilet apparatus 1 returns to the standby state for the toilet flushing.

According to the flush water tank device 4 of the embodiment of the present invention, the ball tap 16 is configured to supply flush water into the inner tank 14, and the flush water supplied into the inner tank 14 overflows from the entire perimeter of the inner tank 14 to flow into the outer tank 12. Therefore, the edge over which the flush water flows can be lengthened, and the water level of flush water flowing over the edge of the inner tank 14 can be kept low. Consequently, the space to be provided above the inner tank 14 can be set low, and the flush water tank device 4 can be designed with a low profile.

According to the flush water tank device 4 of the present embodiment, since the length of the outer perimeter of the upper end of the inner tank 14 is set to ½ or more of the length of the outer perimeter of the upper end of the outer tank 12, the edge of the inner tank 14 over which the flush water flows can be set sufficiently long, and the water level of the flush water flowing over the edge of the inner tank 14 can be kept low.

According to the flush water tank device 4 of the present embodiment, since the inner tank 14 is configured so that the cross-sectional area of the upper part of the inner tank 14 is larger than the cross-sectional area of the lower part, the edge of the inner tank over which the flush water flows can be formed long. As a result, the water level of the flush water flowing over the edge of the inner tank 14 can be kept low. Furthermore, since the inner tank 14 is configured so that the cross-sectional area of the upper part is larger than the cross-sectional area of the lower part, a large amount of flush water having a large head pressure is stored in the inner tank 14. Consequently, the instantaneous flow rate of flush water drained from the inner tank 14 can be increased, and the flush toilet main body 2 can be effectively flushed.

According to the flush water tank device 4 of the present embodiment, since the ball tap 16 is configured to cause flush water to flow into the inner tank 14 from the water supply port 32a provided below the water surface of the inner tank 14, rippling of the flush water flowing into the inner tank 14 from the water supply port 32a can be suppressed. As a result, even if the space above the inner tank 14 is set low, concern of equipment disposed above the inner tank 14 being covered with water can be reduced, and the flush water tank device 4 can be designed with the low profile.

According to the flush water tank device 4 of the present embodiment, since the inner tank 14 is configured so that the length of the outer perimeter of the upper end of the inner tank is longer than the length of the outer perimeter of the upper end of the outer tank 12, the edge of the inner tank 14 over which flush water flows can be set extremely long, and the water level of the flush water flowing over the edge of the inner tank 14 can be kept sufficiently low.

As described above, the flush water tank device of the embodiment of the present invention and the flush toilet apparatus including the same have been described, and various changes can be made to the above-described embodiment. In particular, in the above-described embodiment, the flush water stored in the inner tank is spouted from the jet spout port, and the flush water stored in the outer tank is spouted from the rim spout port. In contrast, as a modification, the present invention may be configured so that the flush water of the inner tank is spouted from the rim spout port, and the flush water of the outer tank is spouted from the jet spout port. Alternatively, the present invention can be applied to a flush water tank device that supplies flush water to a flush toilet main body including a spout port other than the rim spout port and the jet spout port.

Furthermore, in the above-described embodiment, the ball tap is used as the water supply valve for switching the supply and stop of flush water to be stored in the outer tank and the inner tank, and a water supply valve other than the ball tap may be used. Furthermore, in the above-described embodiment, the second discharge valve is driven by the hydraulic drive mechanism, and the hydraulic drive mechanism may not be provided.

### REFERENCE SIGNS LIST

1 flush toilet apparatus
2 flush toilet main body
2a bowl
2b discharge trap conduit
2c rim spout port
2d jet spout port
2e rim conduit
2f jet conduit
4 flush water tank device
4a lever handle
6 water supply source
8 first discharge valve (first water discharge/stop switching mechanism)
8a bead chain
10 second discharge valve (second water discharge/stop switching mechanism)
10a valve shaft
12 outer tank
12a first drain port
12b second drain port
14 inner tank
14a drain port
14b drain port forming member
14c cutout
14d cutout
16 ball tap (water supply valve)
16a inflow pipe
16b outflow pipe
18 hydraulic drive mechanism
18a cylinder
18b piston
18c spring
20 main body
20a main valve body
20b valve seat
20c bleed hole
20d pressure chamber
20e pressure passage
22 float
24 arm
24a support shaft
26 pilot valve
26a pilot valve port
28 rod
30 clutch mechanism
32 water supply pipe
32 water supply port

1. A flush water tank device that is attached to a flush toilet main body for use to supply flush water, comprising:
an outer tank that stores flush water to be supplied to the flush toilet main body,
an inner tank made of resin, that is disposed inside the outer tank and stores flush water to be supplied to the flush toilet main body,
a water supply valve that switches supply and stop of flush water to be stored in the outer tank and the inner tank,
a first water discharge/stop switching mechanism disposed inside the outer tank and outside the inner tank to switch supply and stop of flush water stored in the outer tank to the flush toilet main body, and
a second water discharge/stop switching mechanism disposed inside the inner tank to switch supply and stop of flush water stored in the inner tank to the flush toilet main body, wherein
the water supply valve is configured to supply flush water into the inner tank, and the flush water supplied into the inner tank overflows from two or more sides of the inner tank to flow into the outer tank.

2. The flush water tank device according to claim 1, wherein the inner tank is configured so that a length of an outer perimeter of an upper end of the inner tank is ½ or more of a length of an outer perimeter of an upper end of the outer tank.

3. The flush water tank device according to claim 1, wherein the inner tank is configured so that a cross-sectional area varies in a height direction and so that a cross-sectional area of an upper part of the inner tank is larger than a cross-sectional area of a lower part.

4. The flush water tank device according to claim 1, wherein the water supply valve is configured to cause flush water to flow into the inner tank from a water supply port provided below the water surface of the inner tank.

5. The flush water tank device according to claim 1, wherein the inner tank is configured so that a length of an outer perimeter of an upper end of the inner tank is longer than a length of an outer perimeter of an upper end of the outer tank.

6. A flush toilet apparatus which is flushed with flush water stored in a flush water tank, comprising:
a flush toilet main body including a bowl, a rim spout port, and a jet spout port, and
the flush water tank device according to claim 1 that supplies flush water to the rim spout port and the jet spout port of the flush toilet main body.
